(19) United States
(12) Patent Application Publication
(10) Pub. No.: US 2007/0126223 A1
(43) Pub. Date: Jun. 7, 2007

(54) Assembly unit consisting of a safety belt and a deflection fitting

(75) Inventor: Karl Moendel, Schwaebisch Gmuend (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/604,913

(22) Filed: Nov. 28, 2006

(30) Foreign Application Priority Data
Dec. 2, 2005 (DE) 10 2005 057 738.5

(51) Int. Cl. B60R 22/00; A44B 11/00

(52) U.S. Cl. 280/808; 24/265 BC; 297/483

(57) ABSTRACT

A safety belt in combination with a deflection fitting is described. The deflection fitting includes a deflection surface across which the safety belt extends. The deflection surface has a width which is smaller than the width of the safety belt.

The invention relates to an assembly unit consisting of a safety belt and a deflection fitting.

### BACKGROUND OF THE INVENTION

Deflection fittings for vehicle safety belts are known in a vast variety of designs. Common to almost all structures is the provision of a deflection surface across with the safety belt extends and which is curved in one direction and extends in one direction vertical to straight line. Generally expressed, the deflection surface has in most cases the shape of a cylinder half. Connecting sections which connect the deflection surface to an attachment section adjoin the two ends of the deflection surface. The attachment section serves to receive for example an attachment screw by means of which the deflection fitting may be attached to a height adjuster or directly to a vehicle body.

In most cases, the two connecting sections pass into the deflection surface in a softly rounded shape. In this manner the two connecting sections offer a stop face for the belt webbing, when the same is obliquely drawn across the deflection surface. On the whole, a through space for the safety belt is delimited between the deflection surface, the two connecting sections and the attachment section, this through space being considerably larger than the width of the safety belt. This is also due to the fact that the width of the deflection surface, measured parallel to its longitudinal axis, is larger than the width of the safety belt.

In practice, it has turned out that under extreme loads, as occur in an accident, the safety belt slips on the deflection surface along the longitudinal axis thereof. This results in the safety belt collecting on one side of the deflection surface and the connecting section situated there, which in the extreme case may result in the deflection fitting pivoting about the attachment screw. This is considered to be undesirable.

It is the object of the invention to provide a deflection fitting that prevents the safety belt from slipping on the deflection surface.

### BRIEF DESCRIPTION OF THE INVENTION

For this purpose an assembly is provided consisting of a safety belt and a deflection fitting. The deflection fitting includes a deflection surface across which the safety belt extends. The deflection surface has a width, and the safety belt has a width, The width of the deflection surface is smaller than the width of the safety belt. A deflection surface that is narrower than the safety belt results in the latter necessarily resting in each operating state already against at least one of the connecting sections. Also in the case of high loads this prevents the safety belt from shifting on the deflection surface in an undesirable manner.

Advantageous designs of the invention will be apparent from the sub-claims.

### BRIEF DESCRIPTION OF THE DRAWINGS

The invention will be described in the following with the aid of two embodiments which are represented in the accompanying drawings in which:

FIG. 1 schematically shows an assembly unit in accordance with the invention;

FIG. 2 shows a side view of the deflection fitting of FIG. 1;

FIG. 3 shows a perspective view of the deflection fitting of FIG. 1; and

FIG. 4 shows a design variant of a deflection fitting for an assembly unit in accordance with the invention.

### DETAILED DESCRIPTION OF THE INVENTION

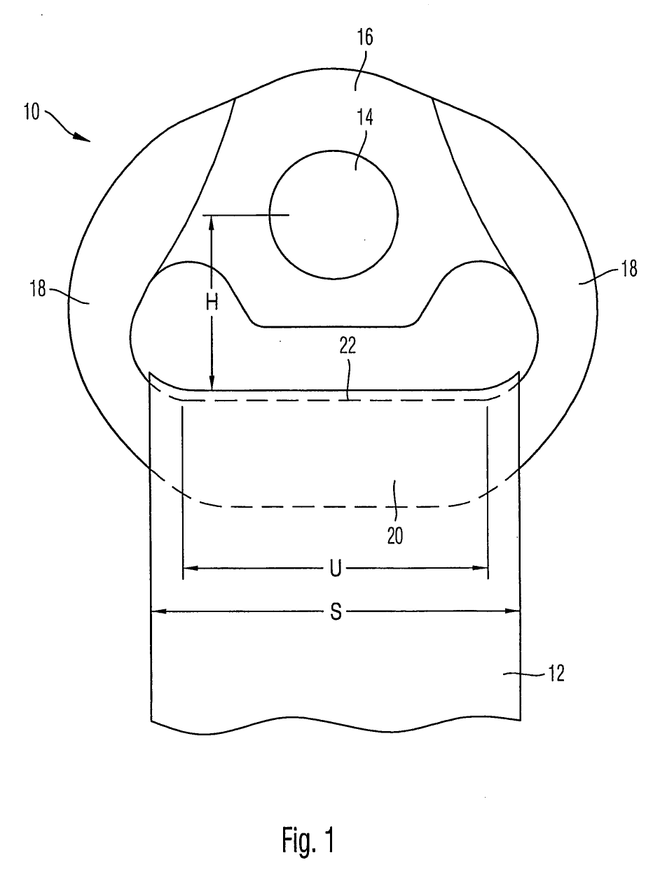

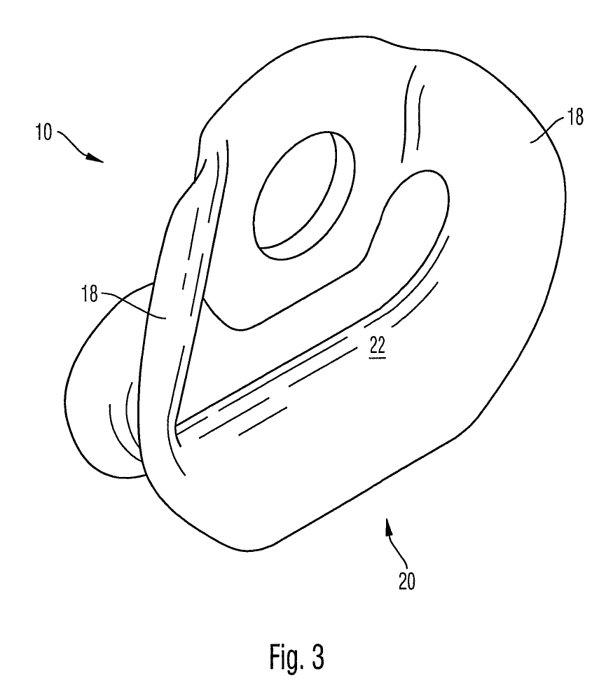

FIGS. 1 to 3 show a deflection fitting 10 which serves to guide and deflect a safety belt 12 of a motor vehicle. For this purpose the deflection fitting 10 is usually attached to a B-column or C-column of a vehicle. To this end the deflection fitting 10 is provided with an attachment opening 14 in an attachment section 16; an attachment screw (not shown) may be inserted through the attachment opening 14. One connecting section 18 each adjoins the attachment section 16 on both sides. The two connecting sections 18 pass into a deflection section 20 whose surface facing the attachment section 16 serves as a deflection surface 22 for the safety belt 12.

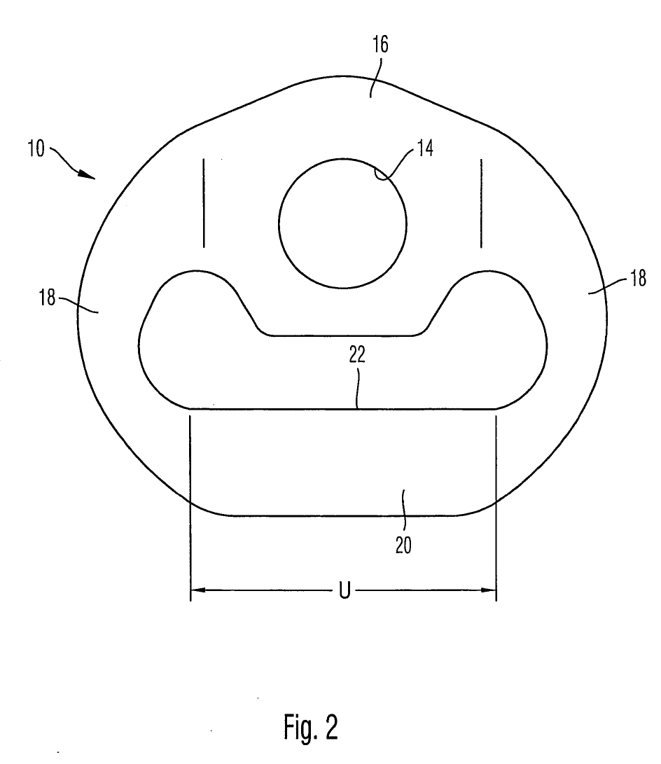

The deflection surface 22 is curved in one direction, so that the safety belt 12 is softly deflected. In a direction perpendicular thereto, the deflection surface 22 is flat (see in particular FIG. 2). The width U of the deflection surface, measured up to the beginning of the connecting sections 18, i.e. measured across the flat part as viewed in the longitudinal direction of the deflection section 20, is smaller than the width S of the safety belt. As apparent in FIG. 1, the safety belt 12 projects on both sides beyond the deflection surface 22 and extends onto the connecting sections 18. For the purpose of a smooth guidance of the safety belt 12 both connecting sections 18 are softly curved adjacent to the deflection surface 22.

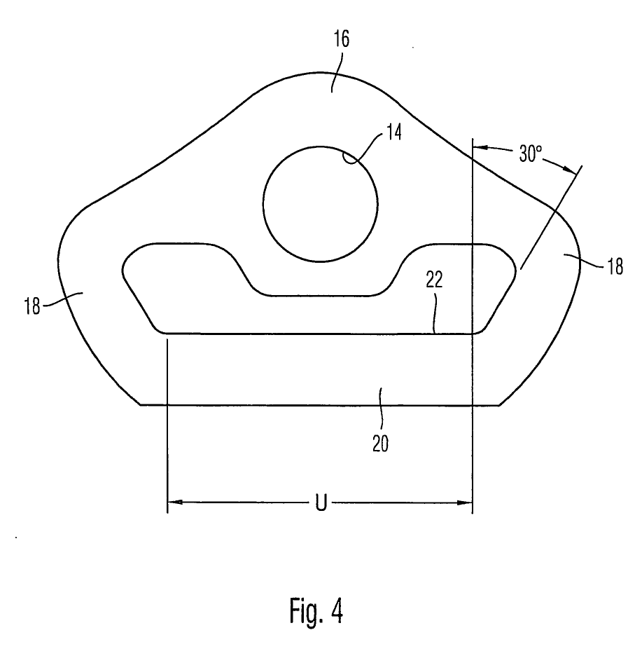

In FIG. 4, a design variant of the deflection fitting 10 is shown. It differs from the deflection fitting shown in FIGS. 1 to 3 by the connecting sections 18 extending in a straight line and obliquely adjacent to the deflection surface 22 (apart from a short curved transition). The angle between a vertical onto the deflection surface 22 and the direction of extension of the inner side of the connecting sections 18 amounts to 30°.

A further feature of the deflection fittings shown in FIGS. 1 to 4 is that the distance H between the central point of the attachment opening 14 and the deflection surface 22 amounts to at least 20 mm (see FIG. 1). The deflection fitting may consist of any suitable material, in particular plastic material or steel. The surface area of the deflection surface 22 is intended to have a peak-to-valley height R_{z} of at least 30 μm, before it is coated. In particular in the case of a deflection fitting made of steel it is possible to use as a coating a sliding layer on the basis of Teflon or a powder coating by means of which also various colors may be represented.

1. An assembly unit consisting of a safety belt and a deflection fitting, said deflection fitting including a deflection surface across which said safety belt extends, wherein said deflection surface has a width and said safety belt has a width, said width of said deflection surface being smaller than said width of said safety belt.

2. The assembly unit of claim 1 wherein a curved connecting section adjoins said deflection surface on both sides.

3. The assembly unit of claim 1 wherein an obliquely extending connecting section adjoins said deflection surface on both sides.

4. The assembly unit of claim 1 wherein said deflection fitting consists of steel.

5. The assembly unit of claim 1 wherein said deflecting fitting consists of plastic material.

6. The assembly unit of claim 1 wherein a distance between a central point of an attachment opening for said deflection fitting and said deflection surface amounts to at least 20 mm.

7. The assembly unit of claim 1 wherein the surface area of the deflection surface has a peak-to-valley height R_{z} of at least 30 μm.
